(19) United States
(12) Patent Application Publication
(10) Pub. No.: US 2019/0126391 A1
(43) Pub. Date: May 2, 2019

(54) METHOD FOR DETERMINING THE POSITION OF THE FOCUS OF A LASER BEAM ARRANGEMENT AND METHOD FOR PROCESSING A WORK PIECE WITH LASER BEAMS

(71) Applicant: Technical University of Munich, Munich (DE)

(72) Inventors: Andreas GANSER, Munich (DE); Peter FAGERER, Ainring (DE)

(21) Appl. No.: 16/083,476

(22) PCT Filed: Feb. 6, 2017
(86) PCT No.: PCT/EP2017/052503

§ 371 Date: Sep. 7, 2018

(30) Foreign Application Priority Data
Mar. 11, 2016 (DE) 10 2016 204 071.5

(51) Int. Cl. B23K 26/046; B23K 26/38

(52) U.S. Cl. CPC B23K 26/046; B23K 26/38

(57) ABSTRACT

The position of the focus of a laser beam arrangement relative to a reference surface is determined by (A) irradiating a laser beam on the reference surface, (B) measuring the intensity of reflection light generated by the surface due to the laser beam, wherein in (C), (A) and (B) are repeated for a plurality of different, effective distances between the surface and the arrangement, and (D) that effective distance is determined as the focal distance representative for the position of the focus for which the measured or an interpolated intensity of reflection light is extremal, if, (E) every time (A) and (B) are performed, the arrangement and surface are moved relative to each other so the laser beam sweeps across a surface area of the reference surface that has a stronger direct reflection and weaker diffuse reflection, and sweeps across a structure formed in its interior that has a stronger diffuse reflection and weaker direct reflection.

### CROSS-REFERENCE TO RELATED APPLICATIONS

This application is a National Stage of International Application No. PCT/EP2017/052503, filed Feb. 6, 2017, which claims priority based on German Patent Application No. 10 2016 204 071.5, filed Mar. 11, 2016, the entire disclosures of which are incorporated herein by reference.

### TECHNICAL FIELD

The present invention relates to a method for determining the position of the focus of a laser beam arrangement and a method for processing a work piece with laser beams.

### BACKGROUND

The use of laser beams for processing work pieces of different materials finds increasing application in various technical fields, in manufacturing as well as in repairing methods.

When material surfaces are processed by means of laser beams, the position of the focus of the laser beam with respect to the surface of the material to be processed is of crucial importance. For this reason, different devices and methods have been developed, which for example allow to determine the position of the focus of a laser beam with respect to a material surface by means of beam profile identification.

However, what is disadvantageous in conventional approaches, among other things, is the comparatively high expenditure on equipment for determining the focus as well as the comparatively high time requirements that are necessary for installing known measuring arrangements.

The invention is thus based on the objective of identifying methods for determining the position of the focus of a laser beam arrangement as well as methods for processing a work piece by means of laser beams in which the position of the focus of a used laser beam arrangement with respect to a reference surface can be determined by particularly simple means, and yet in a reliable manner.

### SUMMARY

According to the invention, the objective that the invention is based on is achieved by means of a method for determining the position of the focus of a laser beam arrangement with the features of the independent patent claim 1 as well as alternatively with the features of the independent patent claim 4, and by means of a method for processing a work piece with laser beams according to the invention with the features of the independent patent claim 13. Advantageous further developments are defined in the dependent claims.

According to a first aspect of the present invention, a method for determining the position of the focus of a laser beam arrangement with respect to a reference surface is provided, comprising the following steps: (A) irradiating a laser beam on the reference surface by means of the laser beam arrangement and (B) measuring the intensity of the direct and/or diffuse reflection light generated by the reference surface in response to the laser beam. Here, (C) the steps (A) and (B) are repeated for a plurality of different, respectively fixed effective distances between the reference surface and the laser beam arrangement. (D) That effective distance between the reference surface and the laser beam arrangement is determined as the effective focal distance or focus distance that is representative for the position of the focus for which the measured or an interpolated intensity of the reflection light is extremal, that is, takes the form of a minimum or a maximum. According to the invention, (E) every time the steps (A) and (B) are performed, the laser beam arrangement and the reference surface are moved in such a manner with respect to each other that the laser beam completely sweeps across a surface area or section of the reference surface that has a stronger direct reflection and weaker diffuse reflection, and in doing completely so sweeps across a structure formed in its interior with a stronger diffuse reflection and weaker direct reflection.

Thus, the core idea of the present invention according to the first aspect is to detect reflection light from the reference surface, whether it be the result of a direct reflection or a diffuse reflection or scattering, as the laser beam sweeps across it, with respect to a more highly reflective surface area in which a structure that is less directly reflecting and has a stronger diffuse reflection is formed.

Different shares of direct and diffuse reflection light result during a complete sweep of the laser beam with respect to the surface area and thus during a complete sweep across the structure with weaker direct reflection but stronger diffuse reflection or scattering. These shares vary depending on the distance of the focus of the laser beam arrangement from the impingement point on the reference surface. The extremal values of the intensities for the different distances as the laser beam sweeps across the surface area and the structure formed therein or the correspondingly interpolated values indicate the actual focal distance of the laser beam arrangement with respect to the reference surface.

Thus, according to the invention, the focus position of the laser beam arrangement with respect to the reference surface can be inferred in a simple manner and without high expenditure on equipment based on the measured direct and/or diffuse reflection light alone.

It is possible to differentiate between the reflection light from a direct reflection and the reflection light from a diffuse reflection, which in this case can be referred to as scattered light.

Correspondingly, it is provided according to a preferred embodiment of the method according to the invention that the intensity of direct reflection light is measured and that an effective distance between the reference surface and the laser beam arrangement is determined as the focal distance that is representative for the position of the focus for which the measured or an interpolated intensity of the direct reflection light is minimal. In this case, the laser beam arrangement can possibly be operated with a reduced power in order to avoid unintended material processing at the reference surface during the determination of the focal distance and/or in order not to damage a used detector appliance.

As an alternative or in combination with this, it can be provided according to another further development of the method according to the invention that the intensity of the diffuse reflection light is measured and that an effective distance between the reference surface and the laser beam arrangement is determined as the focal distance that is representative for the position of the focus for which the measured or an interpolated intensity of the diffuse reflection light is maximal.

Although the method according to the invention including sweeping across a more highly reflective area with a less reflective structure in its interior is clearly in the foreground, according to a further aspect of the present invention also a method for determining the position of the focus of a laser beam arrangement with respect to a reference surface can be proposed, in which such a structure is not decisive. The alternative comprises the steps of: (A) irradiating a laser beam on the reference surface by means of the laser beam arrangement and (B-2) measuring the intensity of diffuse reflection light generated by the reference surface in response to the laser beam. Here, (C) the steps (A) and (B-2) are repeated for a plurality of different, respectively fixed effective distances between the reference surface and the laser beam arrangement. (D-2) That effective distance between the reference surface and the laser beam arrangement is determined as the focal distance that is representative for the position of the focus for which the measured or an interpolated intensity of the diffuse reflection light is maximal.

Thus, the core idea of the alternative or additional aspect of the present invention without the diffusely reflecting structure on the reference surface is to use diffuse reflection light alone, which provides different intensities as a measurement variable in particular by forming a vapor capillary depending on the distance of the focus from the reference surface and thus also depending on the beam widening.

By changing the focus position with respect to the work piece and thus with respect to the reference surface, the dimensions of the vapor capillary, e.g. the diameter and depth, are changed. In this manner, a change in the ratio of the power absorbed in the vapor capillary to the performance which is reflected in the surface next to the vapor capillary occurs. In this manner, the share of direct and diffuse reflection is changed.

If the focus of the laser beam is on the surface, that is, on the reference surface, the intensity of diffusely reflected light, that is, of scattered light, becomes maximal there.

Particularly advantageous is the analysis of diffuse scattered light, because no determined angular relationship has to be observed like with direct reflection. It is entirely sufficient if a fixed angular relation between the incident laser beam, the reference surface and the used measuring arrangement is maintained.

Here, it can also be taken into account that the characteristic scattered beams can depend on the process regimen and the surface characteristics. If the roughness of the metal is low a normal distribution can be assumed, for example for the diffuse reflection, in case the reflection occurs at a solid phase.

In contrast to the first concept of the invention, the second concept does not require that a more strongly diffusely reflecting or scattering structure is proved or swept across on the reference surface. The measuring of diffuse reflection light at different effective distances is sufficient.

The aspects or concepts the invention is based on can be combined with each other.

Thus, it can be provided according to a further development of the method according to the invention according to the second aspect that, (E) with every performance of the steps (A) and (B), the laser beam arrangement and the reference surface are moved in such a manner with respect to each other that the laser beam completely sweeps across a surface area of the reference surface that has a stronger direct reflection and weaker diffuse reflection, and in doing so completely sweeps across a structure formed in its interior that has a stronger diffuse reflection and weaker direct reflection.

Above and as well as in the following, the term direct reflection light can also be described by the terms directly reflected light, directly reflected beam, direct reflection beam. Accordingly, the terms diffuse reflection light and scattered light can be described by the terms diffusely reflected light, diffusely reflected beam, diffuse reflection beam, scattered beam.

A particularly high measure of comparability and reproducibility in the steps of the irradiation of the laser beam and of measuring the intensity result when, according to an advantageous further development, the steps (A) and (B) are performed with a respectively fixed geometry between the reference surface, the laser beam arrangement and a measuring unit.

When it comes to the analysis of diffuse reflection light, there are many different possibilities of mutual orientation of the laser beam, the reference surface and the used measuring unit. Thus, it is principally possible that an observed beam of diffuse reflection light does not lie in a common plane (i) with the incident laser beam and (ii) with a perpendicular on the reference surface that intersects the incident beam.

The method according to the invention is particularly advantageous if the material surface that is connected to the reference surface is not changed through the used laser beam during the determination of the focus position.

Thus, it is provided according to a preferred embodiment of the method according to the invention that an incident laser beam has a power density in the focus which is adjusted to a substrate that the reference surface rests on, and does not cause it to melt.

In connection with a process of the set-up, the method according to the invention can also include aspects of forming the surface areas of the reference surface that has a stronger direct reflection and a weaker diffuse reflection and/or the structure that has a stronger diffuse reflection and weaker direct reflection.

In an advantageous further development of the method according to the invention, it is thus provided that the surface area of the reference surface is formed or provided having a stronger direct reflection and weaker diffuse reflection that a highly reflective material layer, in particular than a surface layer of a work piece to be processed, in the form of a metal foil, preferably made with or of copper, and/or in the kind of a dichroic mirror.

Alternatively or additionally to this, it is provided in another advantageous further development of the method according to the invention that the structure is formed having a stronger diffuse reflection and weaker direct reflection by structuring the interior of the surface area of the reference surface that has a stronger direct reflection and weaker diffuse reflection by means of laser beams and/or ion beam treatment.

The method according to the invention is particularly advantageous in connection with the structure which is to be swept across with the laser beam, if the structure that has a stronger diffuse reflection and weaker direct reflection of the interior of the surface area has a linear expansion that is swept across by the laser beam, which does not exceed the diameter of the laser beam in the focus.

In this case, as the structure with the weaker direct reflection is being swept across, the analysis of the direct or diffuse reflection and its intensity is especially precise and entails particularly low measuring errors.

Even if in connection with the present invention it is often referred to light in the sense of laser light, reflection light, scattered light etc., all spectral areas that a laser treatment can be based on are conceivable.

Thus, according to an advantageous further development of the method according to the invention, it can in particular be provided that laser beams in the visible, ultraviolet and/or infrared range are used.

According to another aspect of the present invention, a method for processing a work piece with laser beams is developed.

According to the invention, the method for processing the work piece with laser beams is characterized in that a laser beam arrangement the method is based on is used before and/or during a processing procedure with respect to the surface of the work piece as a reference surface with a method according to the invention for detecting the position of the focus of the laser beam arrangement with respect to the reference surface to align the used laser beam arrangement with respect to the surface of the work piece as a reference surface.

### BRIEF DESCRIPTION OF THE DRAWINGS

Further details, features and advantages of the invention follow from the following description and the Figures.

FIG. 1 is a schematic side view of an arrangement in which an embodiment of the method according to the invention can be used for determining the position of the focus of a laser beam arrangement.

FIGS. 2 and 3 are schematic side views that illustrate aspects of another embodiment of the method according to the invention for determining the position of the focus of a laser beam arrangement.

FIGS. 4 to 6 show different aspects in determining a position of the focus of a laser beam arrangement according to the present invention in the form of graphs.

### DETAILED DESCRIPTION

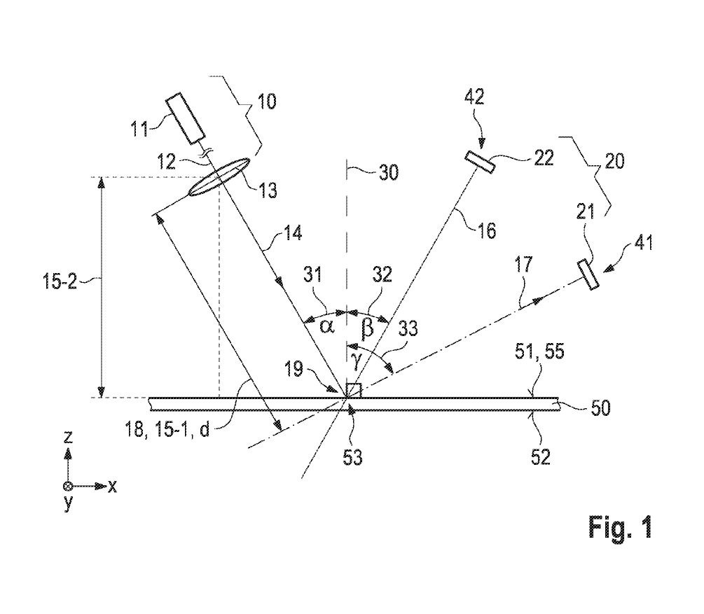

In the following, exemplary embodiments of the invention are described in detail based on FIGS. 1 to 6. Identical and equivalent elements and components as well as elements and components that appear to be identical or equivalent are indicated by identical reference signs. The detailed description of the indicated elements and components is not given in every case where they occur.

The shown features and further characteristics can be combined in any form in isolation and in any combination with each other, without departing from the core of the invention.

As has already been explained above, two basic concepts can be differentiated in connection with the present invention:

(1) According to a first concept, a surface area of the reference surface is completely swept across by the laser beam on the reference surface at different but fixedly chosen distances, and in the course of this procedure, also a structure is detected which in comparison to the rest of the surface area has a weaker direct reflection but a stronger diffuse reflection or scattering. In this concept, the light from the direct reflection as well as the light from the diffuse reflection or scattering can be used for the analysis.

(2) In the second concept that the invention is based on, such a surface structure on the reference surface is not primarily important. Rather, the second concept of the present invention is based exclusively on the analysis of diffuse reflection or scattered light at different but fixedly set distances.

FIG. 1 shows, in a schematic side view, an arrangement on which the second concept can be based, among others.

The reference surface 55 in question is formed by the top side 51 of a work piece 50 to be processed, which incidentally also has a bottom side 52. In the example shown in FIG. 1, the reference surface 55 is a flat surface that is parallel to the xy-plane. With its thickness, the work piece 50 extends in the z-direction.

Positioned above a reference surface 55 is a laser beam arrangement 10. It consists of a laser appliance 11, which is also referred to in short as a laser and creates a primary beam 12, as well as a laser exit optical system 13 which transforms the primary beam 12 into a secondary beam 14 in an optically processed form and irradiates it on the reference surface 55. In the following, the secondary beam 14 can also be referred to as the incident laser beam or as the incident beam.

The laser exit optical system 13 is positioned at an effective distance 15-1 from the reference surface 55 and the impingement point 53 of the laser beam 14 located there. The effective distance 15-1, which is also indicated by d in the following, describes the length of the light path of the secondary beam or laser beam 14 from the laser exit optical system 13 up to the impingement point 53 of the laser beam 14 on the reference surface 55. This effective distance 15-1 is ideally identical to the focal distance or effective focal point distance 18 of the laser exit optical system 13, which in the following is also indicated as the dfocus, since only in that case the maximal power density impinges at the impingement point 53 on the reference surface 55 for processing the work piece 50. With effective distances 15-1 that differ from the effective focal point distance 18, the beam 14 is widened with respect to the diameter 43 of the beam 14 in the focus 19, and thus has a lesser power density than in the case where it is focused.

With respect to the reference surface 55, the laser beam 14 impinges at an angle of incidence 31 relative to the perpendicular 30 on the reference surface 55 in the impingement point 53. Due to the interaction with the top side 51 of the work piece 50 as the reference surface 55, generally a determined portion of the laser beam 14 is directly reflected at an angle of reflection 32 as a detection angle at direct reflection, which is identical with the angle of incidence 31. Other portions of the incident laser beam 14 are reflected in a diffused manner and leave the reference surface 55 at a scattering angle 33 as diffused reflection light or scattered light 17.

On the one hand, in principle the directly reflected light 16 can be measured at an angle of reflection 32 that is identical with the angle of incidence 31 at a—in this case second—measuring position 42 by means of a second detector 22 of the measuring unit 20. However, here it is disadvantageous that an increased expenditure on equipment is necessary to ensure that the angle of reflection 32 and the angle of incidence 31 are identical. Moreover, the incident laser beam 14, the perpendicular 30 in the impingement point 53 and the directly reflected light beam 16 must be located in one plane.

According to the invention, according to the second concept the invention is based on, only the detection of the diffuse reflection light or scattered light 17 is significant, which, with respect to the incident laser beam 14, can be detected in any desired, but fixed, scattering angle 33 as a detection angle with diffuse reflection or scattering by means of a first detector 21 at a first measuring position 41 of the measuring unit 20. The scattered light 17 can also be described with the terms diffuse reflected beam or scattered beam.

This means that according to the invention the expenditure on equipment for detecting the scattered light 17 is comparatively low. It only has to be ensured that the angles 31 and 33 are constant, they do not have to be identical.

It remains to be stated that what is important in the description of the arrangement or geometry shown in FIG. 1 is not primarily the direct, perpendicular or shortest distance 15-2 of the laser exit optical system 13 from the reference surface 55, but rather the effective distance 15-1 that describes the length of the light path from the laser exit optical system 13 up to the impingement point 53.

In connection with the above-described second concept of the present invention, the effective distance 15-1 between the laser exit optical system 13 and the reference surface 55 is simply changed step-wise, preferably in a distance range that comprises the effective focal point distance 18, for setting the effective focal point distance 18 as the effective distance 15-1 of the laser exit optical system 13 from the reference surface 55.

If now the angle of incidence 31 and the scattering angle 33 are kept constant as the effective distance 15-1 is being changed, what results depending on the size of the effective distance 15-1 is a variation in the intensity of the diffusely reflected light or scattered light 17. If the focal point or focus 19 is located directly on the reference surface 55, with the value of the effective distance 15-1 corresponding to the value of the effective focal point distance 18 in that case, the intensity of the diffusely reflected or scattered light 17 in the first detector 21 at the first measuring position 41 is maximal as compared to all other measured intensities of scattered light 17.

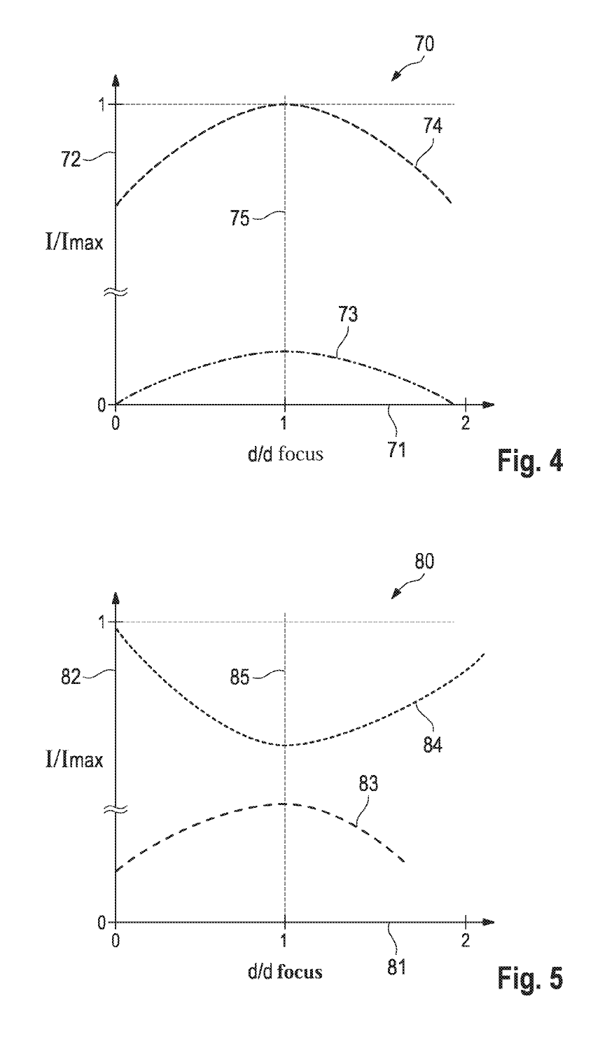

This result will be explained again in more detail in the following in connection with the graph 70 of FIG. 4 and will be described there based on the course of the curve or the path 73.

In FIG. 4, the path 74 schematically shows the course of the measured relative intensity I/Imax depending on the effective distance 15-1, d the laser exit optical system 13 from the reference surface 55 in the analysis of the directly reflected light 16 at the second measuring position 42 by the second detector 22. Here, particularly aspects of forming a vapor capillary may have to be taken into account to facilitate a corresponding analysis of the direct reflection light. The formation of the vapor capillary can be detected by means of measuring the direct or the diffuse reflection, and thus does not necessarily entail any additional expenditure on equipment.

As has been described above, such an analysis is in principle possible, but entails a further increased expenditure on equipment also due to the fact that the angle of incidence 31 and the angle of reflection 32 do not only have to be kept constant over time but also equal to each other, and in addition the incident laser beam 14, the perpendicular 30 at the impingement point 53 on the reference surface 55 and the directly reflected beam 16 have to be fixated by choosing the orientation of the work piece 50, the laser beam arrangement 10 and the measuring unit 20.

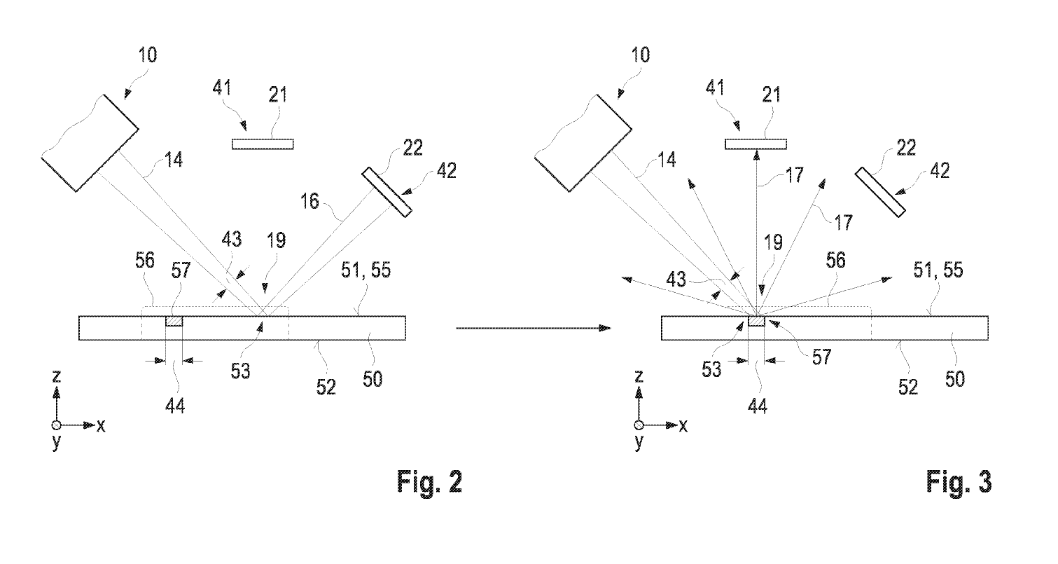

FIGS. 2 and 3 show, in a schematic manner, the use of an arrangement in an embodiment of the method for determining the position of the focus 19 of a laser beam arrangement 10 with respect to a reference surface 55, which is based on the first concept according to the invention.

Thus, the measuring process is based on the complete sweeping across of the laser beam 14 with respect to a surface area 56, wherein in the surface area 56 in its interior a structure 57 is arranged that has a decreased direct reflection and increased diffuse reflection as compared to the surface area 56.

FIGS. 2 and 3 show two intermediate states which can be taken in one embodiment of the method according to the invention according to the first concept.

Here, FIG. 2 shows that the incident laser beam 14 appears at one location 53 of the top side 51 of the work piece 50 as the reference surface 55, which is substantially positioned in the surface area 56 but does not have a separate structure. The surface area 56 has a high direct reflection and a comparatively low diffuse reflection. Significant portions of the laser beam 14 with the diameter 43 in the area of the focus 19 are directly reflected, as has been explained in detail in connection with FIG. 1. The directly reflected beam 16 can be detected with the second detector 22 at the second measuring position 42.

In general, direct reflection as well as diffuse reflection or scattering occurs at every surface. Due to its comparatively small share, the diffuse reflection or scattering 17 is not shown in FIG. 2 in connection with the first detector 21 at the first measuring position 41.

In the surface area 56, the top side 51 as the reference surface 55 is additionally formed with a surface structure 57. It has a linear expansion 44, which lies approximately in the order of magnitude of the beam diameter 43 in the focus 19. The surface structure 57 has a decreased direct reflection as compared to the rest of the surface area 56, but an increased diffuse reflection or an increased scattering power.

The situation shown in FIG. 3 occurs through a relative movement of the arrangement of the laser beam arrangement 10 and the measuring unit 20 in relation to the work piece 50, e.g. through a displacement of the work piece 50 in the x-direction.

In FIG. 3, the incident laser beam 14 completely covers the surface structure 57 of the surface area 56. Due to the decreased direct reflection and increased diffuse reflection of the surface area 57 as compared to the rest of the surface area 56, more diffuse reflection or scattering occurs through the generation of scattered light 17. The decreased direct reflection light 16 is not explicitly shown.

If one regards only the situation shown in FIG. 3, in which the incident laser beam 14 is substantially aligned to the surface structure 57 of the surface area 56, what results from the metrological perspective is the result shown graphically in FIG. 5.

The path 83 of the graph 80 of FIG. 5 shows the course of the intensity of the diffusely scattered light 17 depending on the effective distance 15-1 between the laser beam arrangement 10 and its laser exit optical system 13 with respect to the impingement point 53 on the top side 51 of the work piece 50 as the reference surface 55.

What can be seen is an intensity maximum for the case that the effective distance 15-1, d coincides with the effective focal distance 18, dfocus, i.e. the condition d=dfocus is met. If the beam 14 is widened by defocusing, i.e. in the case that the laser beam arrangement 10 is moved further towards or away from the impingement point 53 on the top side 51, the intensity of the scattered lights 17 is reduced.

Accordingly reversed results occur in the measurement of the direct reflection light 16 by means of the second detector 22 at the second measuring position 42.

In the focused state with d=dfocus, in which the effective distance 15-1 corresponds to the effective focal distance 18, as the laser beam 14 impinges, it substantially covers the surface structure 57 in its width 44 with its beam width 43 under the given angular conditions. Under these circumstances, the surrounding highly reflective section of the further surface area 56 is not impinged by the laser beam 14, so that the intensity of the direct reflection light 16 is minimal.

During defocusing, i.e. as the laser beam arrangement 10 is moved away from or moved towards the impingement point 43 on the top side 51 of the work piece 50, the beam 14 is quasi locally widened, and thus not only the surface structure 57 is impinged with a minimal direct reflection and maximal diffuse reflection, but also the neighboring highly reflective areas, so that the intensity of the direct reflection light 16 increases, starting at the minimum.

In the following, also general explanations of the FIGS. 4 and 5 are provided:

In the paths 73, 74, 83, 84, the graphs 70 and 80 of FIG. 4 or 5 represent courses of the normed intensity as a function of the normed distance of the laser beam arrangement 10 from the impingement point 53 on the top side 51 as a reference surface 55.

Here, the abscissas 71 and 81 show the effective distance 15-1 or d in relation to the focal distance 18 or dfocus. On the ordinates 72 or 82, the intensity I is respectively set in relation to the maximal intensity Imax of the directly reflected light 16 under optimal conditions.

As has already been explained above, the courses 73 and 83 show the dependence of the diffusely scattered light 17 with respect to highly reflective sections of the surface area 56, or as the surface structure 57 is swept across with a high share of diffuse reflection.

In contrast, the courses of the curves 74 and 84 show the dependence of the intensity of directly reflected light 16, and namely again as highly reflective sections of the surface area 56 or the surface structure 57 with a reduced direct reflection and increased diffuse reflection is swept across.

The auxiliary lines 75 and 85 facilitate the detection of the extremes of the courses of the curves 73, 74, 83, 84 and indicate the respectively focused state.

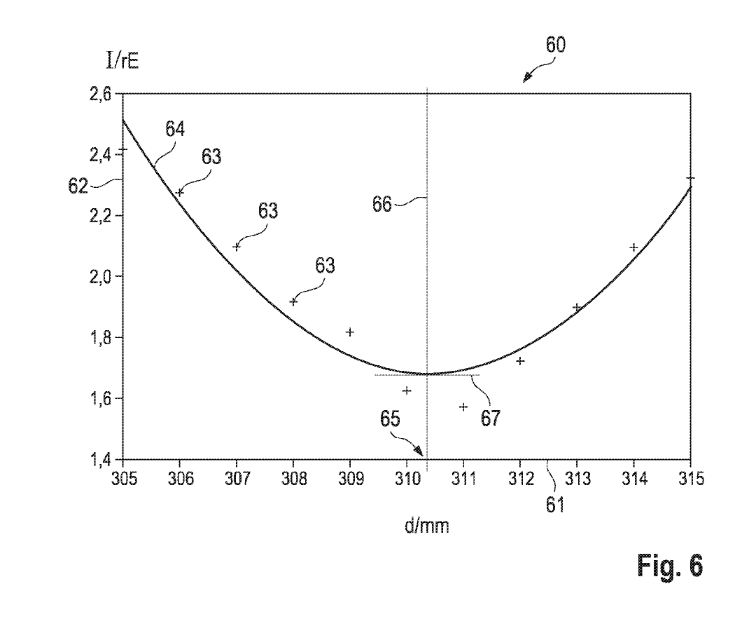

FIG. 6 shows a graph 60 in which the effective distance 15-1 or d of the laser beam arrangement 10 from the impingement point 53 on the top side 51 of the work piece 50 as the reference surface 55 is indicated on the abscissa 61 in millimeters. On the ordinate 62, the intensity I of the direct reflection light 16 at the second measuring position 42 is indicated, similar to the course of the curve 84 of FIG. 5.

FIG. 6 illustrates that it is often not possible to directly infer the focal distance 18 from individual measuring points 63, but rather that the rendering by means of an interpolation curve 64 is required to subsequently determine an interpolated value 65 as the effective focal distance 18 with a value of between 310 mm and 311 mm with the help of the abscissa auxiliary line 66 and the ordinate auxiliary line 67 as well as tangent construction.

These and other features and characteristics of the present invention will be further explained based on the following:

Especially joining processes by means of laser beams are characterized by local energy introduction into the work piece. This is possible since the laser beam can be focused on extremely small beam diameters with very high intensities.

Due to the beam caustic of a laser beam, a precise positioning of the welding optics to the work piece and its surface has to be performed for the purpose of focusing. Even small changes in the working distance, that is, the distance between optics and work piece, can considerably influence the intensity of the laser beam on the work piece.

Until now, whenever a welding process based on laser beams is set up, the ideal working distance had to be determined by means of welding tests. Moreover, the focus position can be displaced during the welding processes due to the heating of the optics.

Therefore, what is aimed at is a method for determining the focus which is as simple and fast as possible.

The calibration of the focus position is particularly laborious in conventional scanner optics in which the beam is deflected by mirrors and can be moved across a surface. Here, welding tests across the entire surface have to be performed in order to be able to determine the focus position for each location in an iterative manner.

In addition measuring devices are used for characterizing the beam profile, e.g. having a mechanical scanning diagnosis system for analyzing continuous laser beams. Even if the exact distance of the focus position from the optics can be determined by means of such a measuring device, this approach requires a considerable effort with respect to equipment and metrology.

The goal of the invention is to create a method by means of which the focus position during a laser treatment of a work piece 50 can be determined based on the reflections, and possibly can also be determined during the process.

If the laser beam impinges on the work piece in a defocused state, the performance of the directly or diffusely back-reflecting beams changes, as schematically shown in FIGS. 1 to 3.

The focus position can be determined by measuring the direct and/or diffuse reflection—possibly by scanning or sweeping across a structure that is more strongly diffusely reflecting or scattering as compared to its environment. According to the invention, the focus position is determined based on an intensity minimum of the directly back-reflected beams or an intensity maximum of the diffusely back-reflected beams.

Methods of beam measurement as they have been used so far are disadvantageous due to the expensive measurement technology, the necessarily high expenditure of time and the complex adjustment, e.g. during the welding process. Further, certain approaches in the characterization are not universally applicable and e.g. only possible in a cutting process, but not for welding. Further, it is often necessary to observe geometric boundary conditions, e.g. the requirement of a perpendicular incidence angle. Also, in existing measuring systems, it is not easy to ensure a set-up process that is independent of the processing procedure.

All these disadvantages are avoided thanks to the present invention:

So, it is a goal of the present invention to create a fast and cost-effective measuring method by means of which the ideal working distance between a laser beam arrangement and a surface to be processed can be measured.

For this purpose, according to a first concept of the invention, a structuring 57 is applied to the surface 51 of a more highly or highly reflective material 50 which in particular reflects or scatters less strongly in a direct and comparatively more strongly in a diffuse manner.

By measuring the reflections as the laser beam 14 of a material processing laser 11 of the laser beam arrangement 10 sweeps across the structuring 57, the beam diameter 43 and thus also the ideal working distance can be inferred, since the intensity distribution of the reflections is influenced by the structuring 57. As the structuring 57, macro as well as nanostructures are suitable.

Here, the intensity of the laser beam is in particular chosen in such a manner that no melting of the work piece surface 51 occurs.

FIGS. 2 and 3 schematically show the functional principle of the method according to the invention according to this first concept.

If the laser beam 14 impinges on the structure 57, a portion of it is diffusely reflected, whereby the intensity of the direct reflection is weakened. Thus, an increase in diffuse reflection can be measured at the first measuring position 41 and at the first detector 21 of the measuring unit 20, and a reduction in direct reflection can be measured at the second measuring position 42 and the second detector 22 of the measuring unit 20 as the laser beam 14 sweeps across the structured area 57.

The width 44 of the structuring 57, which is also indicated by dstructure, is in particular chosen in such a manner that it is smaller than or equal to the diameter 43 of the beam 14 in the focus 19, which is also indicated by dbeam. Thus, the condition

dstructure≤dbeam (1)

should advantageously be met.

If the laser beam 14 impinges on the structure 57 in a defocused state, the beam diameter is larger than the structure 57 is wide. In this manner, a portion of the beam 14 impinges on the non-structured and more highly or highly reflective area 56 of the work piece 50, and is thus also directly reflected. The intensity of the direct reflection 16 at the second measuring position 42 is thus minimal if the laser beam 14 impinges on the work piece 50 with the minimal beam diameter 43.

If a measurement is performed at the first measuring position 41, a maximum of diffuse reflection results at a minimal beam diameter 43.

The measurement of the reflections as the laser beam sweeps across the structured area 57 is then repeated for different working distances.

By analyzing the direct and/or the diffuse reflections based on a minimum or maximum of the intensities, the ideal working distance can subsequently be inferred.

Among other materials, copper, on which a structure can be applied by means of a commercially available pulsed laser beam source, e.g. with a labelling laser, is suitable with a view to a simple and cost-effective manufacture of the measuring body, e.g. one that is made with or of a structured and highly reflective material.

Here, the thickness of the measuring body can be adjusted as required. In this way, a copper foil can be structured and can be directly applied to the work piece 50 to be welded during the set-up process.

Also, highly reflective dichroic mirrors can be used. Here, the structure 57 can be applied to the work piece 50, for example by means of an FIB-arrangement (FIB: focused ion beam). With this approach, extremely fine structures 57 can be created.

Likewise suited for measurement of the reflection are simple photodiodes as first and second detectors 21, 22, which are operated in reverse direction in series with a resistor. Through the irradiation of the diodes, a cutoff current is created, generating a voltage drop at the resistor. Based on the measurement of this voltage drop, the intensity can be inferred. Accordingly, the required measurement technology thus has a very simple structure and is cost-effective.

The measuring results shown in FIG. 6 are based on the situation described in the following:

By means of the pulsed laser beam source 11, a 0.3 mm wide structure 57 is applied to a copper sample as a work piece 57. With an applied laser output of 400 W and at a used wave length of 1060 nm, no material processing occurs even in the focus 19 having a beam diameter dbeam=300 μm. For measuring the reflection, a photodiode at the second measuring position 42, as shown in FIGS. 2 and 3, has been chosen, so that the direct reflection 16 was measured.

FIG. 6 shows the course of the intensity minimums for different effective distances 15-1 between the optics 13 and the work piece 50, as they are measured in the process.

In the diagram 60 of FIG. 6, the minimal measured intensity I is mapped in relative units against the effective distance 15-1 or d in mm. Based on the diagram 60, an optimal working distance in the range of between 310 mm and 311 mm can be inferred, since the intensity drop is highest here.

With the approach according to the invention, the focus position 19 in the sense of the focal distance 18 can be determined up to approximately 0.4 mm.

A further improvement of the precision can be achieved by optimizing the surface structure 57 and the measuring position.

The method according to the invention results in the following advantages:
shortening of calibration times (i. e. no reclamping of the work piece is necessary if the latter is flat, and the work piece can remain clamped in, with possibly only a foil having to be applied),
advantageous measurement setup which can be integrated in any optics
quick measurement of a focus shift (change in the working distance due to the heating of the optics) is possible
increase in precision

The necessary measurement setup can be additionally applied as a retrofit kit to existing optics, or can be integrated in the processing optics of the laser beam arrangement. The measurement setup includes detector(s) 21, 22 for measuring the reflection, the measurement technology and the software for analyzing the reflections. Further, it is possible to continuously supply sample bodies that are used as the structure 57 in the sense of the invention.

### LIST OF REFERENCE SIGNS

10 laser beam arrangement
11 laser appliance, laser
12 primary beam
13 laser exit optical system
14 secondary beam, incident laser beam, incident beam
15-1 effective distance between laser exit optical system 13 and reference surface 55
15-2 perpendicular distance between laser exit optical system 13 and reference surface 55
16 direct reflection light
17 diffuse reflected beam/scattered beam, diffusely reflected/scattered beam, scattered light, diffuse reflection light
18 effective focal distance, effective focal point distance
19 focal point, focus
20 measuring unit
21 first detector (for diffusely reflected/scattered light)
22 second detector (for directly reflected light)
30 normal line on the reference surface 55
31 angle of incidence of secondary beam 14
32 angle of reflection/detection angle at direct reflection
33 scattering angle/detection angle at diffuse reflection/scattering
41 first measuring position
42 second measuring position
43 diameter of laser beam 14 in the focus 19
44 diameter of structure 57
50 work piece, target, processing area
51 top side, surface
52 bottom side
53 impingement point of beams
55 reference surface
56 surface area
57 structure
60 graph
61 abscissa
62 ordinate
63 measuring point
64 mean curve
65 value of determined focal distance 15
66 abscissa auxiliary line
67 ordinate auxiliary line
70 graph
71 abscissa
72 ordinate
73 path, course of intensity of diffuse reflection light 17
74 path, course of intensity of direct reflection light 16
75 abscissa auxiliary line
80 graph
81 abscissa
82 ordinate
83 path, course of intensity of diffuse reflection light 17
84 path, course of intensity of direct reflection light 16
85 abscissa auxiliary line
x longitudinal extension direction of reference surface 55
y olique extension direction of reference surface 55
z thickness extension direction

1. A method for determining the position of the focus of a laser beam arrangement with respect to a reference surface, with the steps of:
(A) irradiating a laser beam on the reference surface by means of the laser beam arrangement,
(B) measuring the intensity of the direct and/or diffuse reflection light generated by the reference surface in response to the laser beam,
wherein:
(C) the steps (A) and (B) are repeated for a plurality of different, respectively fixed effective distances between the reference surface and the laser beam arrangement and
(D) that effective distance between the reference surface and the laser beam arrangement is determined as the effective focal distance that is representative for the position of the focus for which the measured or an interpolated intensity of the reflection light is extremal, if
(E) with every performance of the steps (A) and (B), the laser beam arrangement and the reference surface are moved in such a manner with respect to each other that the laser beam completely sweeps across a surface area of the reference surface that has a stronger direct reflection and weaker diffuse reflection, and in doing so completely sweeps across a structure formed in its interior that has a stronger diffuse reflection and weaker direct reflection.

2. The method of claim 1, wherein:
(B-1) the intensity of the direct reflection light is measured and
(D-1) that effective distance between the reference surface and the laser beam arrangement is determined as the effective focal distance that is representative for the position of the focus for which the measured or an interpolated intensity of the direct reflection light is minimal.

3. (canceled)

4. A method of determining the position of the focus of a laser beam arrangement with respect to a reference surface, comprising the steps of:
(A) irradiating a laser beam on the reference surface by means of the laser beam arrangement,
(B-2) measuring the intensity of the diffuse reflection light that is generated by the reference surface in response to the laser beam
wherein:
(C) the steps (A) and (B-2) are repeated for a plurality of different, respectively fixed effective distances between the reference surface and the laser beam arrangement and
(D-2) that effective distance between the reference surface and the laser beam arrangement is determined as the effective focal distance that is representative for the position of the focus for which the measured or an interpolated intensity of the diffuse reflection light is maximal.

5. The method of claim 4, wherein (E), every time the steps (A) and (B) are performed, the laser beam arrangement and the reference surface are moved in such a manner with respect to each other that the laser beam completely sweeps across a surface area of the reference surface that has a stronger direct reflection and weaker diffuse reflection, and in doing so completely sweeps across a structure formed in its interior that has a stronger diffuse reflection and weaker direct reflection.

6.-13. (canceled)

14. The method of claim 1, wherein:
(B-2) the intensity of the diffuse reflection light is measured and
(D-2) that effective distance between the reference surface and the laser beam arrangement is determined as the effective focal distance that is representative for the position of the focus for which the measured or an interpolated intensity of the diffuse reflection light is maximal.

15. The method of claim 2, wherein:
(B-2) the intensity of the diffuse reflection light is measured and
(D-2) that effective distance between the reference surface and the laser beam arrangement is determined as the effective focal distance that is representative for the position of the focus for which the measured or an interpolated intensity of the diffuse reflection light is maximal.

16. The method of claim 1, wherein the steps (A) and (B) are performed in a respectively fixed geometry between the reference surface, the laser beam arrangement and a measuring unit.

17. The method of claim 1, wherein an observed beam of diffuse reflection light is not located in a common plane (i) with the incident laser beam and (ii) with a perpendicular intersecting the incident beam on the reference surface.

18. The method of claim 1, wherein an incident laser beam has a power density in the focus that is adjusted to a substrate on which the reference surface rests, and does not lead to melting of the latter.

19. The method of claim 1, wherein the surface area of the reference surface is embodied or provided so as to have a stronger direct reflection and weaker diffuse reflection than the highly reflective material layer, in particular than a surface layer of a work piece to be processed, in the form of a metal foil, preferably made with or of copper, and/or in the kind of a dichroic mirror.

20. The method of claim 1, wherein the structure that has a stronger diffuse reflection and weaker direct reflection is formed by structuring the interior of the surface area of the reference surface that has a stronger direct reflection and weaker diffuse reflection by means of laser beams and/or ion beam treatment.

21. The method of claim 1, wherein the structure that has a stronger diffuse reflection and weaker direct reflection of the interior of the surface area has a linear expansion that is swept across by the laser beam and that does not exceed the diameter of the laser beam in the focus.

22. The method of claim 1, wherein laser beams in the visible, ultraviolet and/or infrared range are used.

23. A method for processing a work piece with laser beams, wherein, before and/or during a processing procedure, a used laser beam arrangement is aligned with respect to the surface of the work piece as a reference surface with a method according to claim 1.

24. The method of claim 4, wherein the steps (A) and (B) are performed in a respectively fixed geometry between the reference surface, the laser beam arrangement and a measuring unit.

25. The method of claim 4, wherein an observed beam of diffuse reflection light is not located in a common plane (i) with the incident laser beam and (ii) with a perpendicular intersecting the incident beam on the reference surface.

26. The method of claim 4, wherein an incident laser beam has a power density in the focus that is adjusted to a substrate on which the reference surface rests, and does not lead to melting of the latter.

27. The method of claim 4, wherein the surface area of the reference surface is embodied or provided so as to have a stronger direct reflection and weaker diffuse reflection than the highly reflective material layer, in particular than a surface layer of a work piece to be processed, in the form of a metal foil, preferably made with or of copper, and/or in the kind of a dichroic mirror.

28. The method of claim 4, wherein the structure that has a stronger diffuse reflection and weaker direct reflection is formed by structuring the interior of the surface area of the reference surface that has a stronger direct reflection and weaker diffuse reflection by means of laser beams and/or ion beam treatment.

29. The method of claim 4, wherein the structure that has a stronger diffuse reflection and weaker direct reflection of the interior of the surface area has a linear expansion that is swept across by the laser beam and that does not exceed the diameter of the laser beam in the focus.

30. The method of claim 4, wherein laser beams in the visible, ultraviolet and/or infrared range are used.

31. A method for processing a work piece with laser beams, wherein, before and/or during a processing procedure, a used laser beam arrangement is aligned with respect to the surface of the work piece as a reference surface with a method according to claim 4.
